(19) United States
(12) Patent Application Publication
(10) Pub. No.: US 2020/0192984 A1
(43) Pub. Date: Jun. 18, 2020

(54) System and Method for Interactive Table Top Ordering in Multiple Languages and Restaurant Management

(71) Applicant: ATTENDANT.AI, INC, Hacienda Heights, CA (US)

(72) Inventors: Junzhou Chen, Shanghai (CN); Jia Ren, Shanghai (CN); Yun Zhang, Shanghai (CN); Yuxiang Zhong, Shanghai (CN)

(21) Appl. No.: 16/224,687

(22) Filed: Dec. 18, 2018

(51) Int. Cl. G06F 17/28; G06Q 50/12; G06Q 30/06; G10L 15/18

(52) U.S. Cl. CPC G06F 17/289; G06Q 50/12; G06F 17/2818; G10L 15/1822; G06F 17/2872; G06Q 30/0641

(57) ABSTRACT

A system and method for interactive table top ordering in multiple languages and restaurant management provides a table top food and drink ordering device that mounts to table top of a restaurant. The ordering device electronically displays a menu to a customer in a language selected by the customer. The ordering device allows the customer to navigate through the menu to select menu options. The ordering device allows the customer to submit inquiries in a selected language through voice or text for communicating with restaurant employees. The inquiry is translated through a rules based machine translation, or a statistical machine translation, or both, or additional unknown translation methods on a backend network, such as a cloud, and the translation methods can also be expended into others in the future. A translation module comprises a software having Artificial Intelligence processing, and a database to translate the menu order and customer's inquiry to the selected language. The system allows a restaurant manager to manage restaurant logistics, such as analyzing customer orders, billing, training, and ordering supplies.

### FIELD OF THE INVENTION

The present invention relates generally to a system and method for interactive table top ordering in multiple languages and restaurant management. More so, the present invention relates to a system and method that provides an interactive table top food and drink ordering device mounted to the table top, and allows the customer to navigate through the menu for selection of the menu options, and further allows the customer to submit inquiries in a selected language through voice or text for communicating with a restaurant employee; whereby the inquiry is translated through rules based machine translation or statistical machine translation, or both, or additional unknown translation methods on a backend network, such as a cloud, and the translation methods can also be expended into others in the future; whereby the food and drink ordering device translates the menu order and the inquiry in the customer's selected language; and whereby the system provides a software application that allows a restaurant manager to manage business logistics for the restaurant to enable efficient ordering by the customer, billing, and meal serving.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The process of ordering and receiving food and drinks in a restaurant is well known in the art. For example, a customer sits at a table top and a waiter gives the customer a pre-printed document as the menu. The menu includes a number of food items or the like available for consumption at the restaurant. The food items of the menu often include simple items, such as for example a glass of milk or a side of salad, and heavier meals like a plate of spaghetti or a turkey sandwich with chips, lettuce, tomato slice, and pickle. At any rate, the customer peruses the food items in the menu, selects the desired food items for consumption at the restaurant, and orders the selected food items from the waiter, usually orally. The waiter then gives the order to a kitchen, which prepares the order. After the food is cooked, the waiter delivers the selected order to the customer for consumption. The customer usually pays after eating.

Typically, restaurant employees have been the major work force in restaurants industry, serving customers with various needs, including placing orders, serving the food, bringing the bill, refilling the drink and other service-related tasks. However, such restaurant staff, including waiters, are encumbered with disadvantages. For example, the waiter has a limited by physical capacity, whereby even the best waiter cannot serve more than five table tops at the same time. There is also uneven serving quality, high training cost, and a limited language capacity usually limited to one language for communicating with the customer. Thus, a system and method that reduces the dependence on human attendants without sacrificing the user experience is needed.

In general, managing a restaurant is a multi-task job that requires staff coordination; data input from customers, suppliers, and staff; and complex logistics. Many restaurants operate multiple shifts per day and require substantial staffing and management. For example, a quick service restaurant can be open twenty-four hours a day, necessitating three eight-hour shifts or four six-hour shifts per day. Restaurants also offer menus that change from breakfast and lunch and dinner. This increases the complexity of a restaurant's operation. Restaurant managers must implement uniform procedures to ensure uniform, high quality food and to maximize customer satisfaction.

Other proposals have involved systems for serving customers and managing logistics in a restaurant. The problem with these restaurant ordering and management systems is that they do not employ solutions for customers that speak foreign languages. Also, these systems do not utilize data gathered from customers and staff to help management make decisions. Even though the above cited restaurant ordering and management systems meet some of the needs of the market, a system and method for interactive table top ordering in multiple languages and restaurant management is still desired.

### SUMMARY

Illustrative embodiments of the disclosure are generally directed to a system and method for interactive table top ordering in multiple languages and restaurant management. The system and method provides an interactive table top food and drink ordering device that is mounted to the table top. The food and drink ordering device is configured to electronically display a menu to a customer in a language selected by the customer. The food and drink ordering device also allows the customer to navigate through the menu for selection of the menu options.

The food and drink ordering device also allows the customer to submit inquiries in a selected language through voice or text for communicating with a restaurant employee. The inquiry is translated through a rules based machine translation or statistical machine translation, or both, or additional unknown translation methods, and the translation methods can also be expended into others in the future. Thus, the food and drink ordering device comprises a software, Artificial Intelligence processing, and a database to translate the menu order and the customer's inquiry to the selected language. Further, the system and method provides a software application, operable on a personal communication device. The software application allows a restaurant manager to manage business logistics for the restaurant, such as analyzing order by the customer, billing, training, and ordering supplies.

In some embodiments, the method for interactive table top ordering in multiple languages and restaurant management may include an initial Step of providing a food and drink ordering device on a table top, the food and drink ordering device displaying a menu.

The method may further comprise a Step of selecting, by a customer, a language to interact with the food and drink ordering device. The selection can be automatically done by the voice translation system.

Another Step includes navigating the menu through the food and drink ordering device.

In some embodiments, a Step comprises submitting an inquiry to a restaurant employee in the selected language, the inquiry being relevant to the menu.

A Step includes selecting a food or drink item from the menu in the selected language.

In some embodiments, a Step may include transmitting the selection of the food or drink item to the restaurant employee.

A Step comprises translating, through a translation module, the translation module comprising a rules based machine translation or statistical machine translation, or both, or additional unknown translation methods, and the translation methods can also be expended into others in the future.

The method may further comprise a Step of reviewing, by a restaurant manager and the restaurant employee, a restaurant data, the restaurant data including at least one of the following: the food or drink selection by the customer, a language selected by the customer, an allergy of the customer, a food preference of the customer, a review by the customer, a bill for the customer, a salary of the restaurant employee, an inventory of the restaurant, a sales amount for the restaurant, and a financial analysis of the restaurant.

A Step includes changing, by the restaurant employee, the food or drink item based on the restaurant data.

A final Step includes training, by the restaurant manager, the restaurant employee, based at least partially on the restaurant data.

In another aspect, the step of reviewing the restaurant data, is performed through a downloadable software application, or online web application.

In another aspect, the software application is operable through a mobile communication device and the Internet.

In another aspect, the step of transmitting the selection of the food or drink item to the restaurant employee, is performed via a backend network.

The backend network comprises a cloud.

In another aspect, the method further comprises a step of changing, by the restaurant employee, the food or drink item based on the allergy of the customer. Furthermore, notes should be applied to ordered items with ingredients as allergy source, when ordering automatically.

In another aspect, the method further comprises a step of adding, by the restaurant manager, a new menu food or drink item, based at least partially on the restaurant data.

In another aspect, the step of adding, by the restaurant manager, a new menu food or drink item, is based on at least one of the following: the food or drink selection by the customer, the inventory of the restaurant, and the sales amount for the restaurant.

In another aspect, the step of reviewing, by a restaurant manager and the restaurant employee, a restaurant data, is performed with a real time updatable NLPU engine.

In another aspect, the restaurant data is reviewed through a downloadable software application on a mobile communication device or the Internet.

In another aspect, the table top is in a restaurant.

In another aspect, the food and drink ordering device displays the menu item electronically.

In another aspect, the food and drink ordering device comprises a touch screen.

In another aspect, the translation module comprises a processor, the processor including at least one of the following: an algorithm, Artificial Intelligence processing, and a database.

In another aspect, the selected language includes at least one of the following: Mandarin Chinese, Cantonese Chinese, Min Chinese, Wu Chinese, Hakka Chinese, Japanese, Korean, Spanish, French, German, Arabic, and Russian.

In another aspect, the translation module comprises a natural language processing and understanding technology.

In another aspect, the translation module is configured to parse the voice input of the customer into an intention and an entity.

In some embodiments, a system for interactive table top ordering in multiple languages and restaurant management comprises a food and drink ordering device disposed on a table top, the food and drink ordering device displaying a menu, the menu being navigated by a customer for selecting a food or drink item.

The system also includes a language selection member operable with the food and drink ordering device, the language selection member enabling a customer to select a preferred language when selecting the food or drink item.

In some embodiments, the system may further include a translation module translating the selected menu item in the selected language, with a rules based machine translation or statistical machine translation, or both, or additional unknown translation methods, and the translation methods can also be expended into others in the future.

Additionally, the system includes a software application downloadable on a personal communication device, the software application enabling access to a restaurant manager to review a restaurant data with a real time updatable NLPU engine, the restaurant data including at least one of the following: the food or drink selection by the customer, a language selected by the customer, an allergy of the customer, a food preference of the customer, a review by the customer, a bill for the customer, a salary of the restaurant employee, an inventory of the restaurant, a sales amount for the restaurant, and a financial analysis of the restaurant.

In this manner, the restaurant manager changes the food or drink item based on the allergy of the customer. Further, the restaurant manager trains the restaurant employee, based at least partially on the restaurant data. In yet another advantage of the system, the restaurant manager adds a new menu food or drink item, based on at least one of the following: the food or drink selection by the customer, the inventory of the restaurant, and the sales amount for the restaurant.

In another aspect of the system, the translation module further comprises an English recognizer, a Japanese recognizer, a Chinese recognizer, and a general language recognizer.

In another aspect of the system, the software application comprises a language module interface, an orchestration module, meal serving module, a data module interface, and a billing module.

One objective of the present invention is to enable a customer at a restaurant to order from a menu in a selected language, and utilize data from the customer to enhance the restaurant experience.

Another objective is to breaks down the language barriers between restaurants and eaters, allowing eaters to go anywhere in the world enjoying food with the language they are familiar.

Yet another objective is to provide a real time updatable Natural Language Processing Understanding (NLPU) engine to allow business owners to add new menu entries and make it recognizable in real time.

Yet another objective is to provide multiple pre-trained skill sets customized for restaurant business handling various user requests.

Yet another objective is to help the restaurant manager better know the customer's allergies and eating/drinking preferences.

Yet another objective is to reduce the wait time for attendants' attention as the system will be ready to take request anytime.

Yet another objective is to reduce the burden of users to announce allergies and preference as the information will be automatically populated on the request sheet.

Yet another objective is to reduce the operational and training cost significantly.

Yet another objective is to bring standardized services to the restaurants, reduces friction between eaters and business owners.

Yet another objective is to allow business managers, owners, and employees to open up to foreigners with no language limitation.

Yet another objective is to bring significant value to both individual eater and restaurant owners.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a flowchart diagram of an exemplary method for interactive table top ordering in multiple languages and restaurant management, in accordance with an embodiment of the present invention;

FIG. 2 illustrates a block diagram of an exemplary system for interactive table top ordering in multiple languages and restaurant management, in accordance with an embodiment of the present invention; and

FIG. 3 illustrates a flowchart of an exemplary high level logic flow for a customer to order from a menu in multiple languages, and a restaurant manager to manage the generated restaurant data, in accordance with an embodiment of the present invention.

Like reference numerals refer to like parts throughout the various views of the drawings.

### DETAILED DESCRIPTION OF THE INVENTION

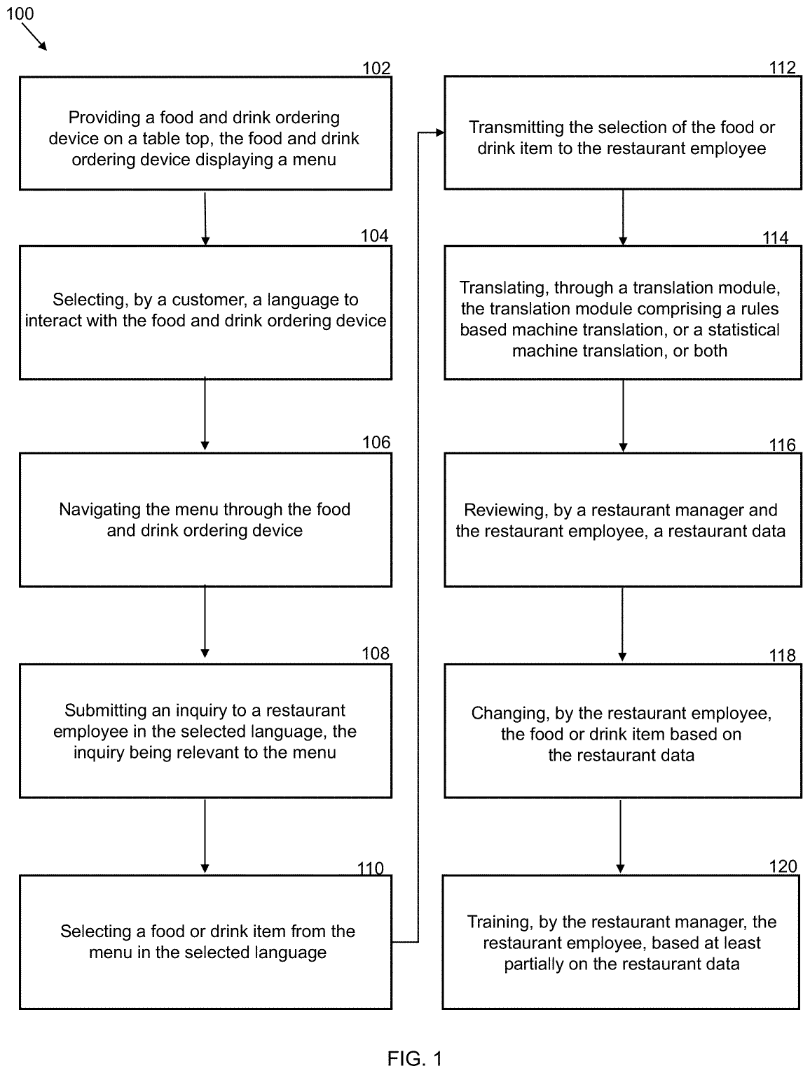

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A system 200 and method 100 for interactive table top ordering in multiple languages and restaurant management is referenced in FIGS. 1-3. The system 200 and method 100 is configured to enable a customer 202 at a restaurant table top to order from a menu in a selected language. The system 200 and method 100 also allows a restaurant manager 204 to utilize data from the customer 202 and restaurant employees to manage logistics, and generally enhance the restaurant experience.

The system 200 and method 100 helps break the language barrier for the customer when ordering through use of a specialized translation software, including natural voice recognition, rules based machine translation, a statistical machine translation, and other translation technology known in the art, to translate the customer's 202 selection for a menu item to a language understood by restaurant employees. The translation of the menu options streamlines the dining process and allows the customer to order more efficiently and comfortably. Thus, the customer 202 can go anywhere in the world and enjoy the food and drink in a familiar language.

In one embodiment, the system 200 and method 100 provides an interactive table top food and drink ordering device 228 that is mounted to the table top. The food and drink ordering device 228 is configured to electronically display a menu to a customer 202 in a language selected by the customer 202. The food and drink ordering device 228 also allows the customer 202 to navigate through the menu for selection of the menu options.

The food and drink ordering device 228 also allows the customer 202 to submit inquiries in a selected language through voice or text for communicating with a restaurant manager and restaurant employee. The inquiry is translated through a rules based machine translation or statistical machine translation, or both, or additional unknown translation methods on a backend network, such as a cloud, and the translation methods can also be expended into others in the future. The food and drink ordering device 228 comprises a software having Artificial Intelligence processing, and a database to translate the menu order and the customer's inquiry to the selected language.

Further, the system 200 and method 100 provides a translation module 206 that translates the customer's order. The translation module 206 comprises a software having Artificial Intelligence processing, and a database to translate the menu order and customer's inquiry to the selected language.

The system 200 and method 100 also allows the restaurant manager 204 to receive and analyze restaurant data 232, so as to manage the restaurant and serve the customer 202 more effectively. For example, the restaurant manager can manage restaurant logistics, such as analyzing customer orders, determining customer allergies, billing customers, training employees, and ordering restaurant supplies.

In some embodiments, the method 100, shown in FIG. 1, includes three components: a voice collection device; a remote cloud backend; and a web or smartphone accessible by the restaurant manager 204. The voice collection device may be positioned on a restaurant table top, and provides the structure, such as a microphone, digital display, and processor that allows the customer 202 to communicate with a backend network, such as a backend remote cloud.

The backend remote cloud is equipped with natural language processing and understanding technology. Also, other language translation algorithms and communication structures that are configured to parse user's voice input into intentions and entities, applying restaurants business logic accordingly and providing voice feedback to customer 202 if needed, printing bills or notifying downstream system 200 for billing purpose.

The web or smartphone based app allows the restaurant manager 204 and owner to manage business logistics. These logistics may include, without limitation, managing menus, setting happy hour timing, setting special menu rules (such as prefix menu), associating device with table numbers, and selecting languages to be available for the device on the desk end.

The invention is unique in that a specific methodology is provided to perform these restaurant-related functions. For example, FIG. 1 illustrates a flowchart diagram of an exemplary method 100 for interactive table top ordering in multiple languages and restaurant management. The method 100 may include an initial Step 102 of providing a food and drink ordering device 228 on a table top, the food and drink ordering device 228 displaying a menu.

In some embodiments, the food and drink ordering device 228 may electronically display the menu item electronically on a touch screen. The food and drink ordering device 228 may include a small kiosk that sits on the table and rotates to accommodate couple people sitting around a table top. The food and drink ordering device 228 may have audible signals, or simply text for communication means.

The method 100 may further comprise a Step 104 of selecting, by a customer 202, a language to interact with the food and drink ordering device 228. The customer 202 can select a language that is familiar. This language will be translated into a language that is familiar with the restaurant employee or restaurant manager 204. A Step 106 includes navigating the menu through the food and drink ordering device 228. The customer 202 can navigate through the menu to choose a desired food or drink. For example the restaurant can order a coffee and a pastry. The customer 202 can also request extra sugar in the coffee, and an extra fork for the pastry so that multiple people can share.

In some embodiments, a Step 108 comprises submitting an inquiry to a restaurant employee in the selected language, the inquiry being relevant to the menu. The inquiry from the customer 202 can include questions about food or drink, allergy risks, prices, and other restaurant related inquiries that a customer 202 may have. A Step 110 includes selecting a food or drink item from the menu in the selected language. The selection is the actual order the customer 202 may push an Order or Enter button to transmit the order.

In some embodiments, a Step 112 may include transmitting the selection of the food or drink item to the restaurant employee. In one possible embodiment, the step of transmitting the selection of the food or drink item to the restaurant employee, is performed via a backend network. The backend network may include a remote cloud or a remote database or server.

A Step 114 comprises translating, through a translation module 206, the translation module 206 comprising a rules based machine translation, or a statistical machine translation, or both, or additional unknown translation methods. The translation method can also be expended into others in the future. Those skilled in the art will recognize that rules based machine translation is a machine translation systems based on large collections of linguistic rules in three different phases: analysis, transfer and generation. These rules are developed by human language experts and programmers who have deployed extensive efforts to understand and map the rules between two languages. Further, rules based machine translation relies on manually built translation lexicons, some of which can be edited and refined by users to improve translation.

Additionally, machine translation systems are based linguistic information about source and target languages basically retrieved from dictionaries and grammars covering the main semantic, morphological, and syntactic regularities of each language respectively. It is also known that statistical machine translation includes a translation system that allows for the translation of text from one human language to another by a computer that learned how to translate from vast amounts of translated text.

In another possible embodiment, the translation module 206 comprises a natural language processing and understanding technology. In another embodiment, the translation module 206 is configured to parse the voice input of the customer 202 into an intention and an entity. The selected language to translate may include, without limitation, Mandarin Chinese, Cantonese Chinese, Min Chinese, Wu Chinese, Hakka Chinese, Japanese, Korean, Spanish, French, German, Arabic, and Russian. However in other embodiments, additional languages may be translated.

The method 100 may further comprise a Step 116 of reviewing, by a restaurant manager 204 and the restaurant employee, a restaurant data 232. The restaurant data 232 includes data relevant to a restaurant and the customer 202. In some embodiments, the restaurant data 232 may include, without limitation, the food or drink selection by the customer 202, a language selected by the customer 202, an allergy of the customer 202, a food preference of the customer 202, a review by the customer 202, a bill for the customer 202, a salary of the restaurant employee, an inventory of the restaurant, a sales amount for the restaurant, and a financial analysis of the restaurant.

In one non-limiting embodiment, the Step 116 of reviewing the restaurant data 232, is performed through a downloadable software application 216. The software application 216 is operable through a mobile communication device and the Internet. The mobile communication device may include, without limitation, a smart phone, a tablet, a laptop, a desktop computer, a mainframe computer, a database, and a server. The step of reviewing can also be performed with a real time updatable NLPU engine. This can include Nuero-Linguistic Programming, or eye-controlled selection from the menu, for example.

A Step 118 includes changing, by the restaurant employee, the food or drink item based on the restaurant data 232. This change can also be based on any possible allergy exhibit by the customer 202. In this Step 118, the customer 202 can transmit information about an allergy. The restaurant employee can make changes to the order or the ingredients for cooking the order based on the allergy of the customer 202. For example, a customer 202 who is allergic to peanuts will not receive food fried in peanut oil. The method restricts such undesirable food orders to protect the customer and the restaurant from damages.

A final Step 120 includes training, by the restaurant manager 204, the restaurant employee, based at least partially on the restaurant data 232. The restaurant manager 204 can use data analysis means known in the art to decipher the restaurant data 232 and train the employees accordingly.

In an alternative embodiment, another Step may include, adding, by the restaurant manager 204, a new menu food or drink item, based at least partially on the restaurant data 232. In an alternative embodiment, the restaurant manager 204 can add a new menu food or drink item, based on the food or drink selection by the customer 202, the inventory of the restaurant, and the sales amount for the restaurant.

Although the process-flow diagrams show a specific order of executing the process steps, the order of executing the steps may be changed relative to the order shown in certain embodiments. Also, two or more blocks shown in succession may be executed concurrently or with partial concurrence in some embodiments. Certain steps may also be omitted from the process-flow diagrams for the sake of brevity. In some embodiments, some or all the process steps shown in the process-flow diagrams can be combined into a single process.

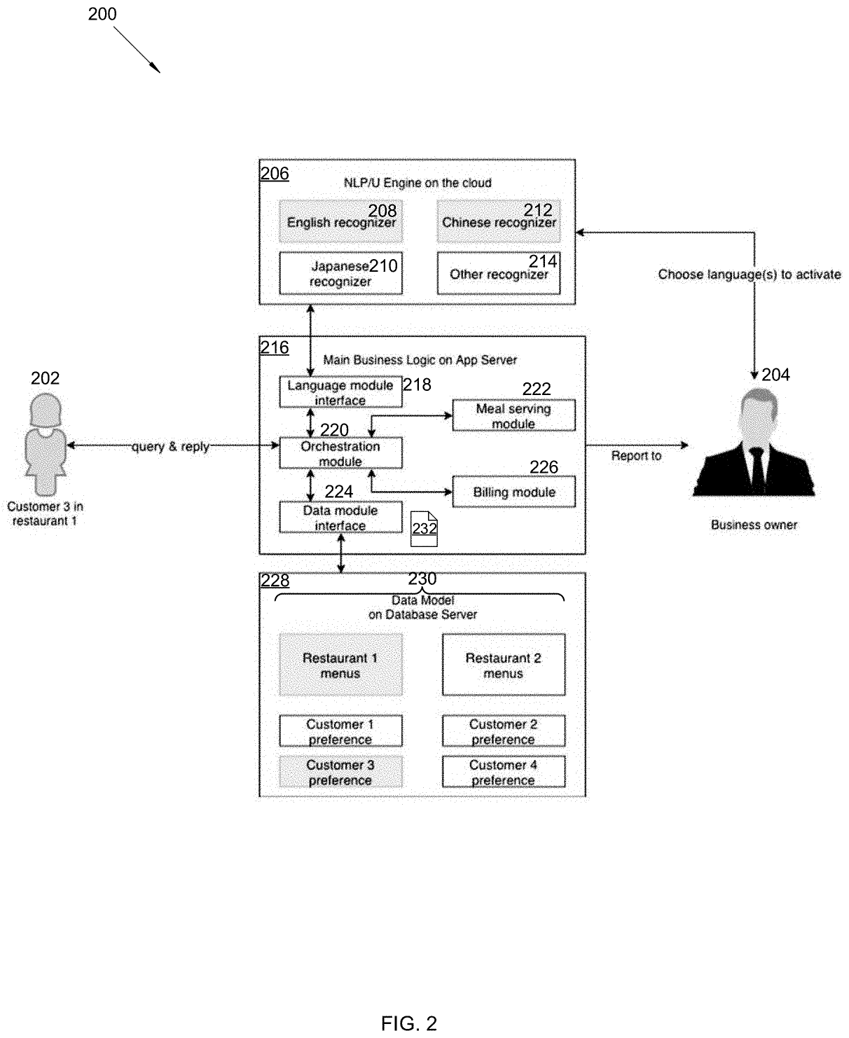

As the block diagram in FIG. 2 references, a system 200 for interactive table top ordering in multiple languages and restaurant management. The system 200 comprises a food and drink ordering device 228 disposed on a table top. The food and drink ordering device 228 electronically displays a menu, which is navigated by a customer 202 for selecting a food or drink item. The system 200 also includes a language selection member operable with the food and drink ordering device 228, the language selection member enabling a customer 202 to select a preferred language when selecting the food or drink item.

The ordering device 228 is unique in that multiple food and drink items are offered in multiple selectable languages. In one embodiment, a plurality of menus and food and drink options 230 appear for the customer 202 to select from. For example, a Restaurant #1 menu offers a User #1 preference and a Use #3 preference. A Restaurant #2 menu offers a User #2 preference and a Use #4 preference. The customer 202 has the option to select any item, through any selected language available.

In some embodiments, the system 200 may further include a translation module 206 that translates the selected menu item by the customer 202 in the selected language. The translation module 206 includes a rules based machine translation, or a statistical machine translation, or both, or additional unknown translation methods, and the translation methods can also be expended into others in the future. Additionally, the system 200 includes a software application 216 downloadable on a personal communication device, the software application 216 enabling access to a restaurant manager 204 to review a restaurant data with a real time updatable NLPU engine.

In some embodiments, the restaurant data 232 may include, without limitation, the food or drink selection by the customer 202, a language selected by the customer 202, an allergy of the customer 202, a food preference of the customer 202, a review by the customer 202, a bill for the customer 202, a salary of the restaurant employee, an inventory of the restaurant, a sales amount for the restaurant, and a financial analysis of the restaurant.

In this manner, the restaurant manager 204 changes the food or drink item based on the allergy of the customer 202. Further, the restaurant manager 204 trains the restaurant employee, based at least partially on the restaurant data 232. In yet another advantage of the system 200, the restaurant manager 204 adds a new menu food or drink item, based on at least one of the following: the food or drink selection by the customer 202, the inventory of the restaurant, and the sales amount for the restaurant.

In another embodiment of the system 200, the translation module 206 further comprises an English recognizer 208, a Japanese recognizer 210, a Chinese recognizer 212, and a general language recognizer 214. However, the translation module 206 may be more general to all languages. Each recognizer provides translation operability for a specific language. For example the Japanese recognizer can translate the customer's Japanese food or drink item selection an English language selection that the restaurant employee can understand. In yet another embodiment of the system 200, the software application 216 comprises a language module interface 218, an orchestration module 220, meal serving module 222, a data module interface 224, and a billing module 226. However, meal serving and billing module are only two examples of business logistic system, but not limited to them. The system can be further integrated to more logistic systems.

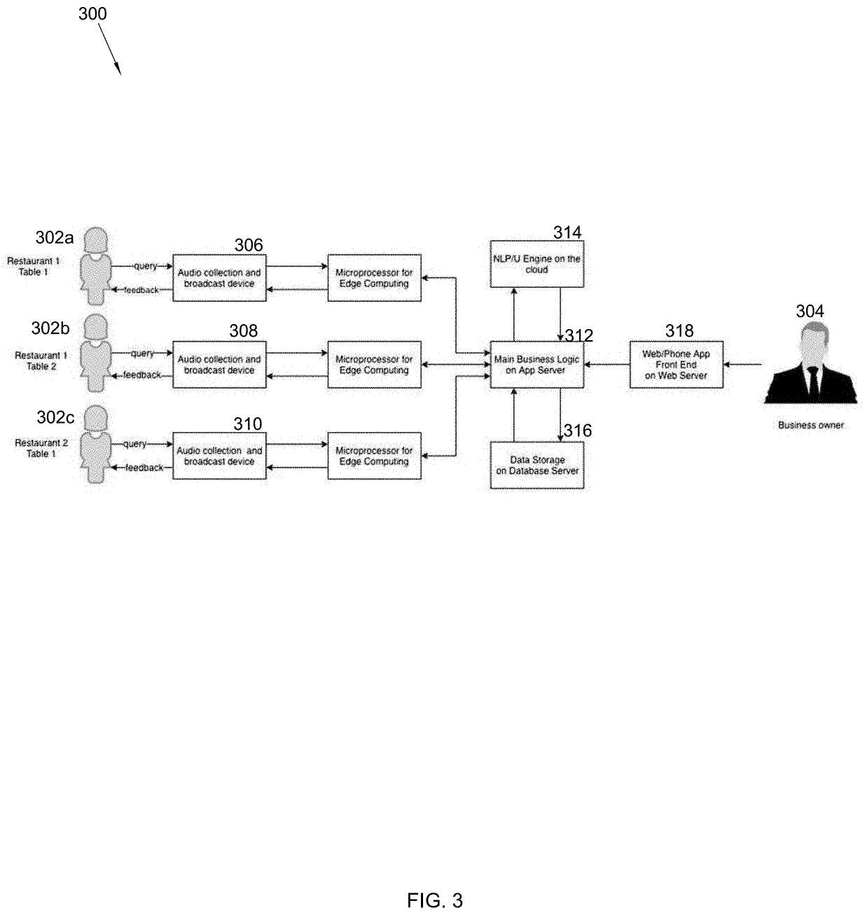

Continuing with the invention, FIG. 3 illustrates a flowchart of an exemplary high level logic flow process 300 that allows a customer 202 to order from a menu in multiple languages, and a restaurant manager 204 to manage the generated restaurant data 232. The process 300 is operable with three table tops 302a, 302b, 302c on which customers order the food and drink item. A restaurant manager or owner 304 has access to the order generated by the customers.

A first voice collection device 306 positions on restaurant table top 302a, and provides the structure, such as a microphone, digital display, and processor that allows the customer to communicate with a backend network, such as a backend remote cloud. A second voice collection device 308 positions on restaurant table top 302b, and provides the structure, such as a microphone, digital display, and processor that allows the customer to communicate with a backend network, such as a backend remote cloud. A third voice collection device 310 positions on restaurant table top 302c, and provides the structure, such as a microphone, digital display, and processor that allows the customer to communicate with a backend network, such as a backend remote cloud.

Continuing with the process 300, a main business logic module 312 is used to receive and translate the order by the customer. The restaurant manager 304 reviews restaurant data with a real time updatable NLPU engine 314. The restaurant data and any other data the restaurant manager 304 finds useful can also be stored on a remote database or server 316. This data can be accessed by the restaurant manager 304 through a front end interface 318. The front end interface 318 may include, without limitation, a computer, laptop, or smart phone having a downloadable software application.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A computer-implemented method for interactive table top ordering in multiple languages and restaurant management, the method comprising:
providing a food and drink ordering device on a table top, the food and drink ordering device displaying a menu;
selecting, by a customer, a language to interact with the food and drink ordering device;
navigating the menu through the food and drink ordering device;
submitting an inquiry to a restaurant employee in the selected language, the inquiry being relevant to the menu;
selecting a food or drink item from the menu in the selected language;
transmitting the selection of the food or drink item to the restaurant employee;
translating, through a translation module, the translation module comprising a rules based machine translation, or a statistical machine translation, or both, or additional unknown translation methods, and the translation methods can also be expended into others in the future;
reviewing, by a restaurant manager and the restaurant employee, a restaurant data, the restaurant data including at least one of the following: the food or drink selection by the customer, a language selected by the customer, an allergy of the customer, a food preference of the customer, a review by the customer, a bill for the customer, a salary of the restaurant employee, an inventory of the restaurant, a sales amount for the restaurant, and a financial analysis of the restaurant;
changing, by the restaurant employee, the food or drink item based on the restaurant data; and
training, by the restaurant manager, the restaurant employee, based at least partially on the restaurant data.

2. The method of claim 1, wherein the step of reviewing the restaurant data, is performed through a downloadable software application.

3. The method of claim 2, wherein the software application is operable through a mobile communication device and the Internet.

4. The method of claim 1, wherein the step of transmitting the selection of the food or drink item to the restaurant employee, is performed via a backend network.

5. The method of claim 4, wherein the backend network comprises a cloud.

6. The method of claim 1, further comprising a step of changing, by the restaurant employee or the restaurant manager, the food or drink item based on the allergy of the customer.

7. The method of claim 1, further comprising a step of adding, by the restaurant manager, a new menu food or drink item, based at least partially on the restaurant data.

8. The method of claim 7, wherein the step of adding, by the restaurant manager, a new menu food or drink item, is based on at least one of the following: the food or drink selection by the customer, the inventory of the restaurant, and the sales amount for the restaurant.

9. The method of claim 1, wherein the step of reviewing, by a restaurant manager and the restaurant employee, a restaurant data, is performed with a real time updatable NLPU engine.

10. The method of claim 1, wherein the food and drink ordering device displays the menu item electronically.

11. The method of claim 1, wherein the food and drink ordering device comprises a touch screen.

12. The method of claim 1, wherein the translation module comprises a processor, the processor including at least one of the following: an algorithm, Artificial Intelligence processing, and a database.

13. The method of claim 12, wherein the translation module comprises a NLPU technology.

14. The method of claim 13, wherein the translation module is configured to parse the voice input of the customer into an intention and an entity

15. The method of claim 1, wherein the selected language includes at least one of the following: Mandarin Chinese, Cantonese Chinese, Min Chinese, Wu Chinese, Hakka Chinese, Japanese, Korean, Spanish, French, German, Arabic, and Russian.

16. The method of claim 1, wherein the step of selecting, by a customer, a language to interact with the food and drink ordering device, further comprises automatically selecting the language based on a user profile or a user first spoken language.

17. A computer-implemented method for interactive table top ordering in multiple languages and restaurant management, the method comprising:
providing a food and drink ordering device on a table top, the food and drink ordering device displaying a menu;
selecting, by a customer, a language to interact with the food and drink ordering device, the selected language including at least one of the following: Mandarin Chinese, Cantonese Chinese, Min Chinese, Wu Chinese, Hakka Chinese, Japanese, Korean, Spanish, French, German, Arabic, and Russian;
navigating the menu through the food and drink ordering device;
submitting an inquiry to a restaurant employee in the selected language, the inquiry being relevant to the menu;
selecting a food or drink item from the menu in the selected language;
transmitting the selection of the food or drink item to the restaurant employee via a backend network;
translating, through a translation module, the translation module comprising a rules based machine translation, or a statistical machine translation, or both, or additional unknown translation methods, translation methods able to be expended into others in the future, the translation module further comprising a processor, the processor including at least one of the following: an algorithm, Artificial Intelligence processing, and a database;
reviewing, by a restaurant manager and the restaurant employee, a restaurant data with a real time updatable NLPU engine, the restaurant data including at least one of the following: the food or drink selection by the customer, a language selected by the customer, an allergy of the customer, a food preference of the customer, a review by the customer, a bill for the customer, a salary of the restaurant employee, an inventory of the restaurant, a sales amount for the restaurant, and a financial analysis of the restaurant;
changing, by the restaurant employee, the food or drink item based on the allergy of the customer;
training, by the restaurant manager, the restaurant employee, based at least partially on the restaurant data; and
adding, by the restaurant manager, a new menu food or drink item, is based on at least one of the following: the food or drink selection by the customer, the inventory of the restaurant, and the sales amount for the restaurant.

18. A computer-implemented system for interactive table top ordering in multiple languages and restaurant management, the system comprising:
a food and drink ordering device disposed on a table top, the food and drink ordering device displaying a menu, the menu being navigated by a customer for selecting a food or drink item;
a language selection member operable with the food and drink ordering device, the language selection member enabling a customer to select a preferred language when selecting the food or drink item;
a translation module translating the selected menu item in the selected language, with a rules based machine translation, or a statistical machine translation, or both, or additional unknown translation methods, and the translation methods can also be expended into others in the future;
a software application downloadable on a personal communication device, the software application enabling access to a restaurant manager to review a restaurant data with a real time updatable NLPU engine, the restaurant data including at least one of the following: the food or drink selection by the customer, a language selected by the customer, an allergy of the customer, a food preference of the customer, a review by the customer, a bill for the customer, a salary of the restaurant employee, an inventory of the restaurant, a sales amount for the restaurant, and a financial analysis of the restaurant;
whereby the restaurant manager changes the food or drink item based on the allergy of the customer;
whereby the restaurant manager trains the restaurant employee, based at least partially on the restaurant data; and
whereby the restaurant manager adds a new menu food or drink item, based on at least one of the following: the food or drink selection by the customer, the inventory of the restaurant, and the sales amount for the restaurant.

19. The system of claim 18, wherein the translation module further comprises a general language recognizer.

20. The system of claim 18, wherein the software application comprises a language module interface, an orchestration module, meal serving module, a data module interface, and a billing module.
